(19) United States
(12) Patent Application Publication
(10) Pub. No.: US 2025/0093863 A1
(43) Pub. Date: Mar. 20, 2025

(54) COMPUTING DEVICE

(71) Applicant: NEC Corporation, Minato-ku, Tokyo (JP)

(72) Inventors: Shinya YASUDA, Tokyo (JP); Hiroshi Yoshida, Tokyo (JP)

(73) Assignee: NEC Corporation, Minato-ku, Tokyo (JP)

(21) Appl. No.: 18/832,584

(22) PCT Filed: Feb. 18, 2022
(86) PCT No.: PCT/JP2022/006669

§ 371 Date: Jul. 24, 2024

(51) Int. Cl. G05B 23/02; B25J 13/08

(52) U.S. Cl. CPC G05B 23/02; B25J 13/08

(57) ABSTRACT

A computing device includes an execution unit that simulates a state of a drive device after the drive device is driven according to a control input, on the basis of a value of the control input capable of being input to the drive device, an analysis unit that selects a main component axis by performing main component analysis on the state distribution of the drive device that is specified through simulations performed a plurality of times by the execution unit, and a determination unit that determines a value to be used for evaluating a candidate for the control input to be input to the drive device, on the basis of a selection result by the analysis unit.

### TECHNICAL FIELD

The present invention relates to a computing device, a determination method, a drive device, a driving method, and a storage medium.

### BACKGROUND ART

There is a case where a drive device such as a robot does not move according to a control input instructed thereto, because of fine error factors such as irregularities on the ground or mechanical play. In the case of evaluating a control input in consideration of such uncertainties, evaluating integration having a form expressed by Expression 1 has been known.

$$\int f ( x ) p ( x ) dx \qquad [ Expression 1 ]$$

In Expression 1, x represents a state of a robot such as a position and orientation of the robot, and f(x) represents a function for evaluating the state. Further, p(x) represents the probability density that takes the state x.

As a method of approximately evaluating the above, for example, a so-called Monte Carlo method is known. In the Monte Carlo method, stochastic differential equations are repeatedly solved numerically, that is, simulations are performed, and for the obtained orbits, evaluation values are calculated and averaged. As a literature in which stochastic differential equations are solved by using the Monte Carlo method, Patent Literature 1 has been known, for example.

Further, as a related literature, Patent Literature 2 has been known, for example. Patent Literature 2 discloses reducing the dimensions of inputs by using main component analysis when there are a large amount of parameters. Patent Literature 2 also discloses selecting a small number of sampling points by executing two references sequentially, and performing simulation operation for the selected sample points.

### CITATION LIST

### Patent Literature

Patent Literature 1: JP 2001-325431 A
Patent Literature 2: JP 2008-523516 A

### Non-Patent Literature

Non-Patent Literature 1: Yu Zhou and G. S. Chirikjian, “Probabilistic models of dead-reckoning error in nonholonomic mobile robots,” 2003 IEEE International Conference on Robotics and Automation, 2003, pp. 1594-1599.
Non-Patent Literature 2: Andrew W. Long, Kevin C. Wolfe, Michael J. Mashner, and Gregory S. Chirikjian, “The Banana Distribution Is Gaussian: A Localization Study with Exponential Coordinates,” in Robotics: Science and Systems VIII, MIT Press, 2013, pp. 265-272.

### SUMMARY OF INVENTION

### Technical Problem

In the case of using the Monte Carlo method as described in Patent Literature 1, when the number of samples is small or the like, oversight may occur in calculation of the evaluation function, so that there is a possibility that the estimated evaluation function value is not stable and that the control becomes unstable. In particular, in the robot control as described above, it is necessary to perform simulations sufficient number of times in the control cycle that is about 1/30 seconds for example, so that the above-described problem becomes noticeable. This causes a problem that it is difficult to improve the control accuracy. Improving the control accuracy in such a short control cycle is difficult even by the art described in Patent Literature 2.

In view of the above, an example object of the present invention is to provide a computing device, a determination method, a drive device, a driving method, and a storage medium capable of solving the above-described problem.

### Solution to Problem

In order to achieve such an example object, a computing device according to an aspect of the present disclosure is configured to include
an execution unit that simulates a state of a drive device after the drive device is driven according to a control input, on the basis of a value of the control input capable of being input to the drive device;
an analysis unit that selects a main component axis by performing main component analysis on the state distribution of the drive device that is specified through simulations performed a plurality of times by the execution unit; and
a determination unit that determines a value to be used for evaluating a candidate for the control input to be input to the drive device, on the basis of a selection result by the analysis unit.

Further, a determination method according to another aspect of the present disclosure is configured to include, by an information processing device,
simulating a state of a drive device after the drive device is driven according to a control input, on the basis of a value of the control input capable of being input to the drive device;
selecting a main component axis by performing main component analysis on the state distribution of the drive device that is specified through simulations performed a plurality of times; and
determining a value to be used for evaluating a candidate for the control input to be input to the drive device, on the basis of a selection result.

Further, a storage medium according to another aspect of the present disclosure is a computer-readable medium storing thereon a program for causing an information processing device to execute processing to
simulate a state of a drive device after the drive device is driven according to a control input, on the basis of a value of the control input capable of being input to the drive device;
select a main component axis by performing main component analysis on the state distribution of the drive device that is specified through simulations performed a plurality of times; and
determine a value to be used for evaluating a candidate for the control input to be input to the drive device, on the basis of a selection result.

Further, a drive device according to another aspect of the present disclosure is configured to include
an estimation unit that estimates an evaluation value corresponding to a candidate for a control input, on the basis of a value used for evaluating the candidate for the control input to be input to the drive device and on the basis of a state of the drive device, the value used for evaluating being determined on the basis of a result of main component analysis with respect to a simulation result using a value of the control input capable of being input to the drive device;
a selection unit that selects a control input to be actually input from among a plurality of the candidates for the control input on the basis of an estimation result by the estimation unit; and
a driving unit that drives the drive device on the basis of a selection result by the selection unit.

Further, a driving method according to another aspect of the present disclosure is configured to include, by a drive device,
estimating an evaluation value corresponding to a candidate for a control input, on the basis of a value used for evaluating the candidate for the control input to be input to the drive device and on the basis of a state of the drive device, the value used for evaluating being determined on the basis of a result of main component analysis with respect to a simulation result using a value of the control input capable of being input to the drive device;
selecting a control input to be actually input from among a plurality of the candidates for the control input on the basis of an estimation result; and
performing driving on the basis of a selection result.

Further, a storage medium according to another aspect of the present disclosure is a computer-readable medium storing thereon a program for causing a drive device to execute processing to
estimate an evaluation value corresponding to a candidate for a control input, on the basis of a value used for evaluating the candidate for the control input to be input to the drive device and on the basis of a state of the drive device, the value used for evaluating being determined on the basis of a result of main component analysis with respect to a simulation result using a value of the control input capable of being input to the drive device;
select a control input to be actually input from among a plurality of the candidates for the control input, on the basis of an estimation result; and
perform driving on the basis of a selection result.

### Advantageous Effects of Invention

According to the configurations described above, it is possible to provide a computing device, a determination method, a drive device, a driving method, and a storage medium capable of improving the accurate control.

### BRIEF DESCRIPTION OF DRAWINGS

FIG. 1 is a diagram illustrating a configuration example of a control system according to a first example embodiment of the present invention.

FIG. 2 illustrates an example of behavior of a drive device.

FIG. 3 is a block diagram illustrating a configuration example of a computing device.

FIG. 4 illustrates an example of control input candidate information.

FIG. 5 illustrates an example of simulation result information.

FIG. 6 illustrates an example of sample point information.

FIG. 7 is a diagram for explaining an example of processing performed by a main component analysis execution unit.

FIG. 8 is a diagram for explaining an example of processing performed by a sample point selection unit.

FIG. 9 is a diagram for explaining an example of processing performed by the sample point selection unit.

FIG. 10 is a diagram for explaining an example of processing performed by a weight calculation unit.

FIG. 11 is a diagram for explaining an example of processing performed by the weight calculation unit.

FIG. 12 illustrates an example of simulation results.

FIG. 13 is a diagram for explaining an example of processing performed by a data conversion unit and an inverse conversion unit.

FIG. 14 is a block diagram illustrating a configuration example of a drive device.

FIG. 15 illustrates an example of evaluation.

FIG. 16 is a flowchart illustrating an example of operation of a computing device.

FIG. 17 is a flowchart illustrating another example of operation of the computing device.

FIG. 18 is a flowchart illustrating an example of operation of a drive device.

FIG. 19 illustrates an example of hardware configuration of a computing device according to a second example embodiment of the present disclosure.

FIG. 20 is a block diagram illustrating a configuration example of a computing device.

FIG. 21 is a block diagram illustrating a configuration example of a drive device.

### DESCRIPTION OF EMBODIMENTS

### First Example Embodiment

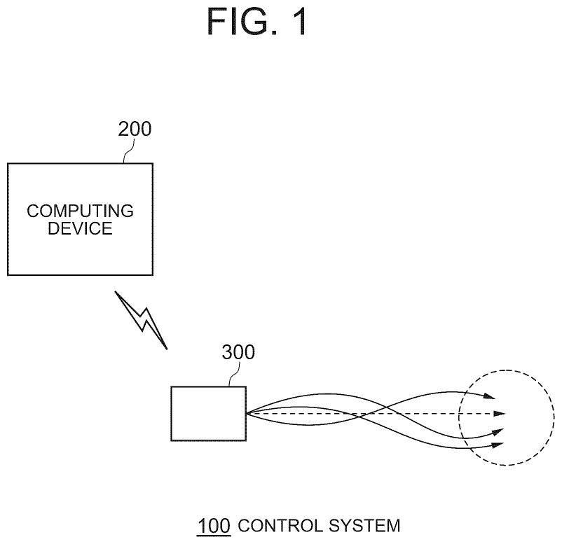

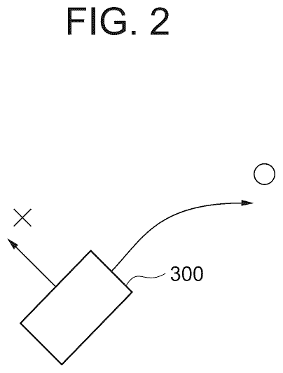

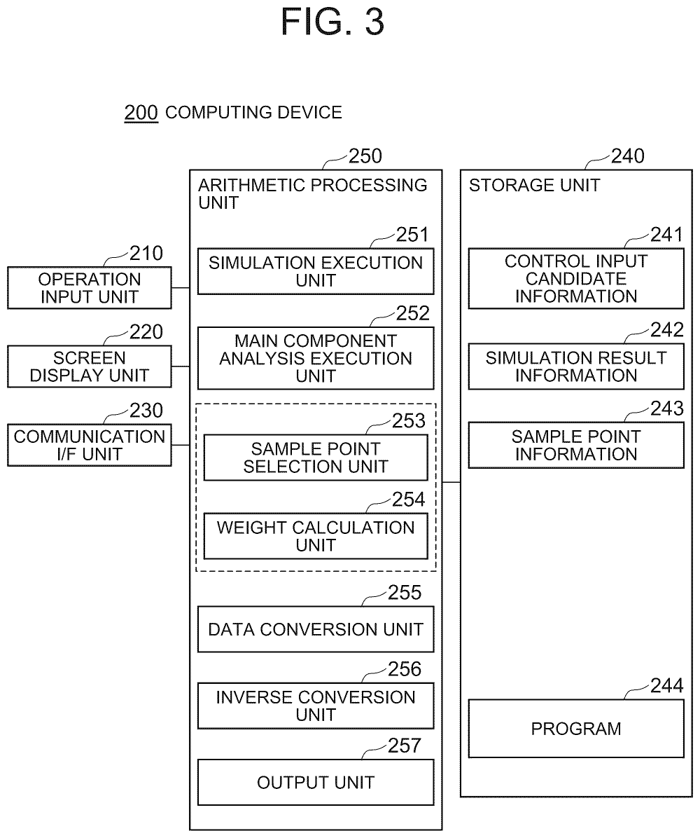

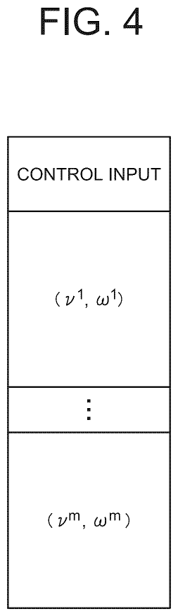

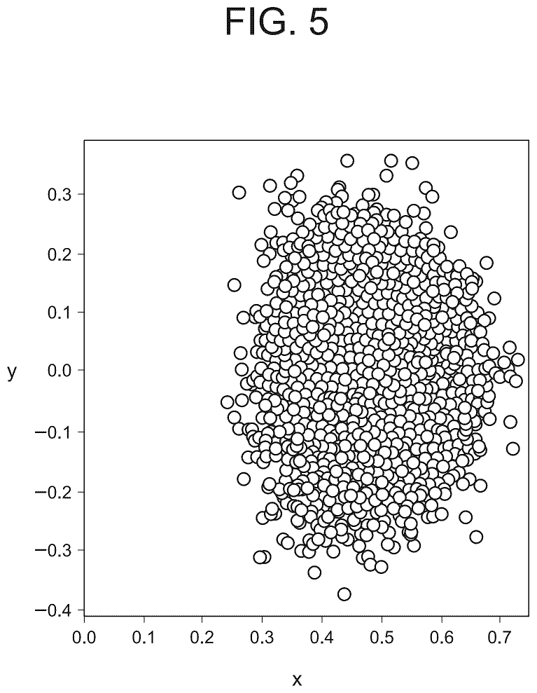

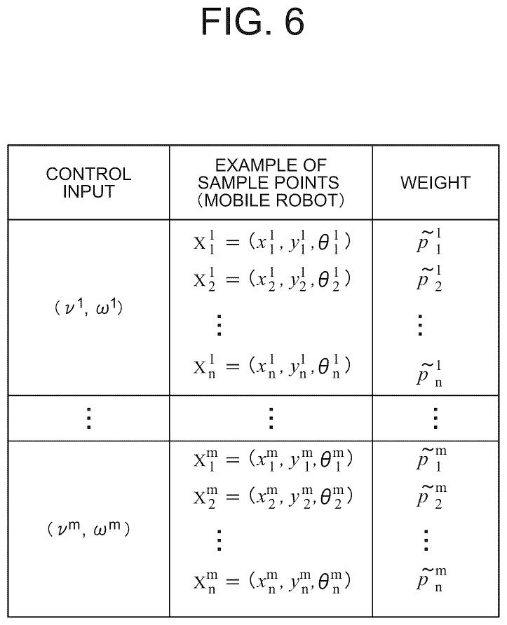

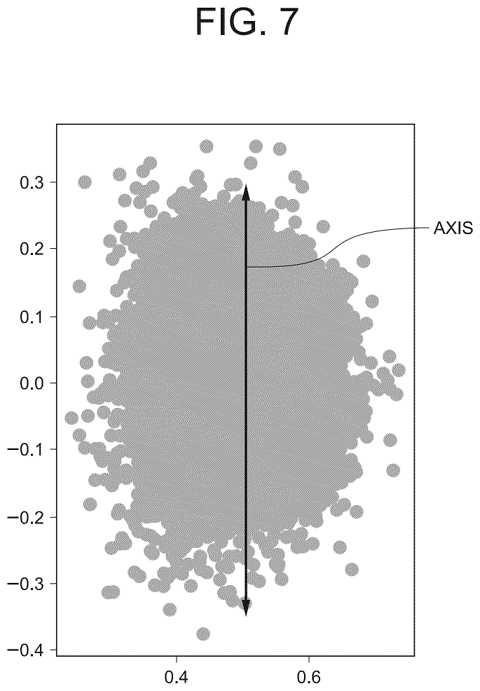

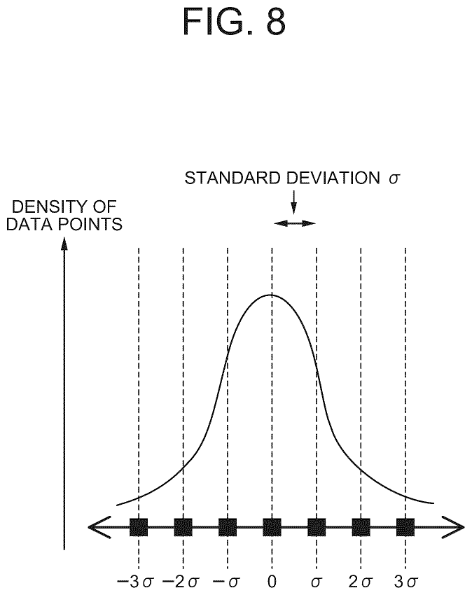

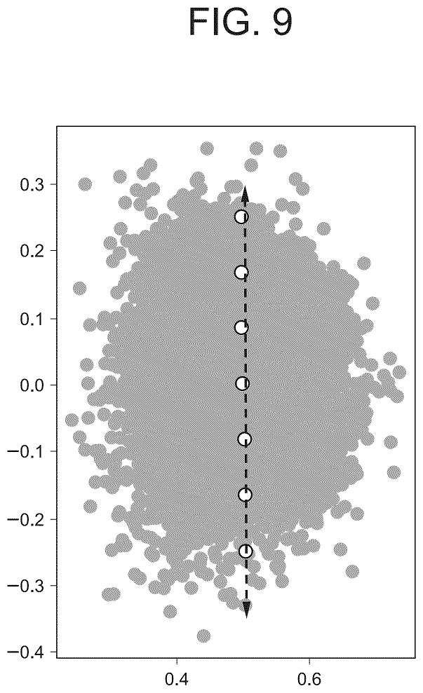

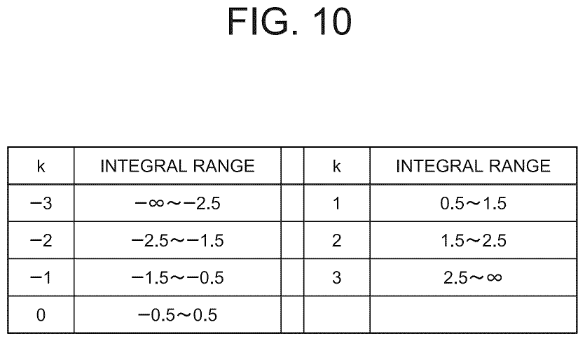

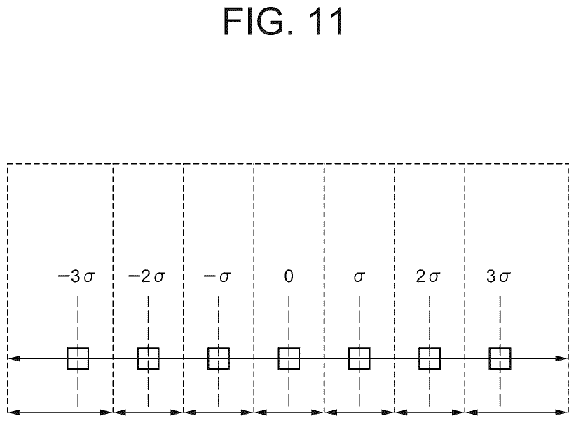

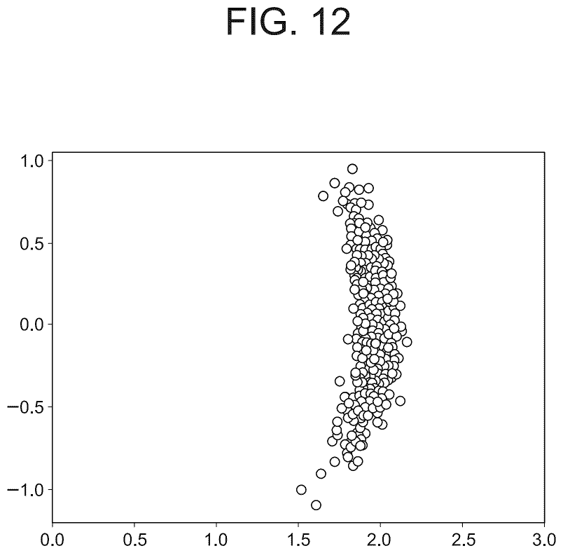

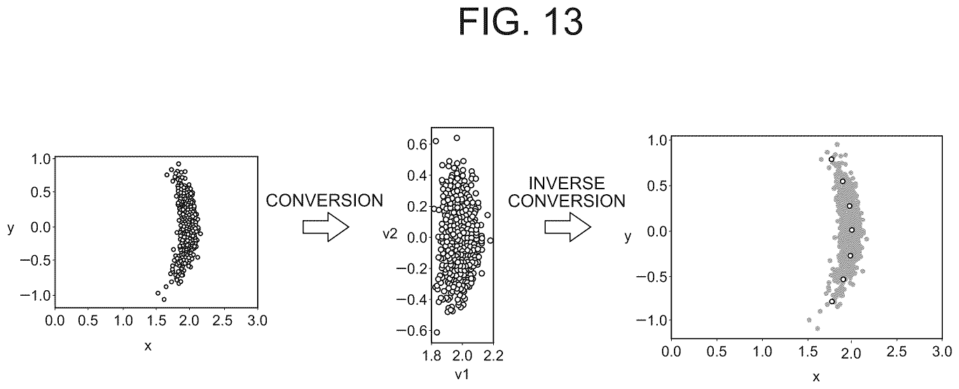

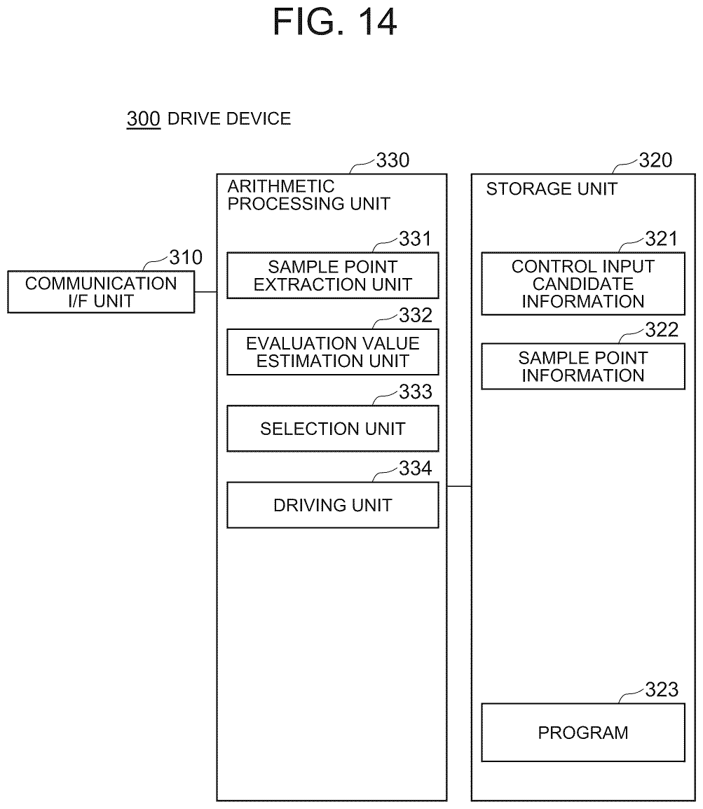

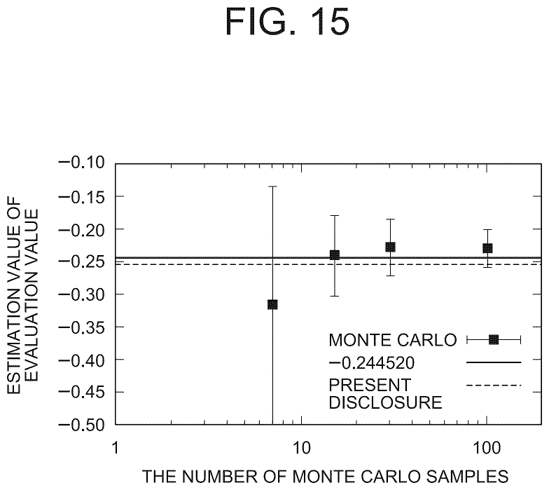

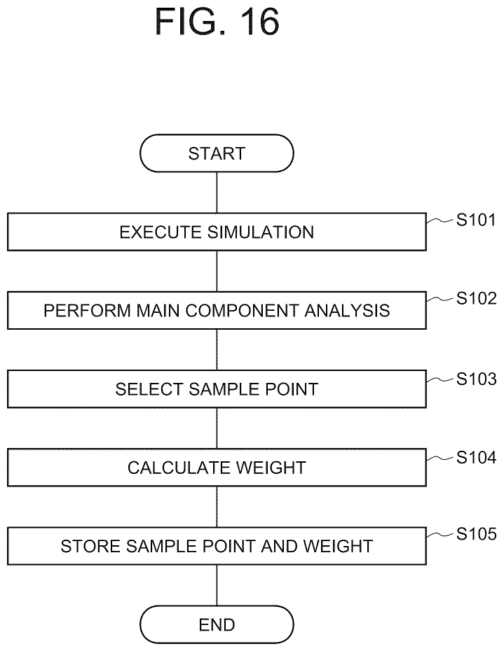

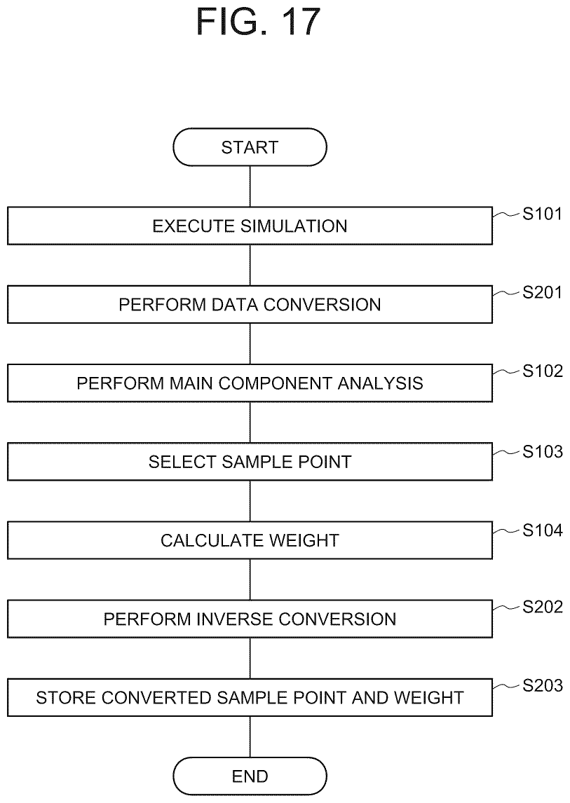

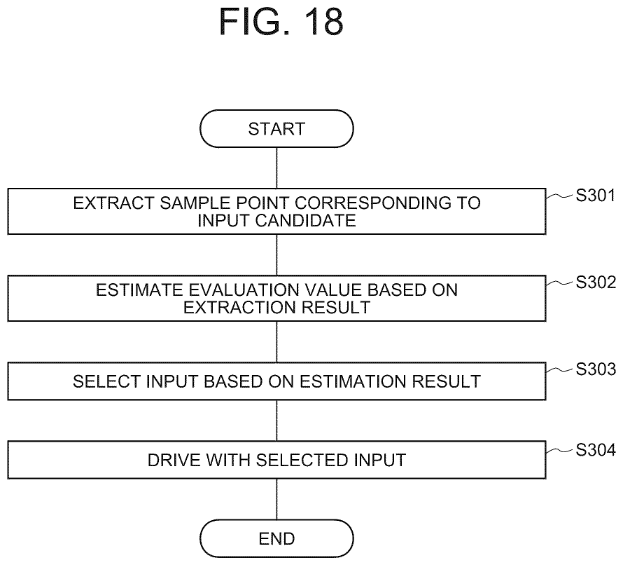

A first example embodiment of the present disclosure will be described with reference to FIGS. 1 to 18. FIG. 1 illustrates a configuration example of a control system 100. FIG. 2 illustrates an example of behavior of a drive device 300. FIG. 3 is a block diagram illustrating a configuration example of a computing device 200. FIG. 4 illustrates an example of control input candidate information 241. FIG. 5 illustrates an example of simulation result information 242. FIG. 6 illustrates an example of sample point information 243. FIG. 7 is a diagram for explaining an example of processing performed by a main component analysis execution unit 252. FIGS. 8 and 9 are diagrams for explaining an example of processing performed by a sample point selection unit 253. FIGS. 10 and 11 are diagrams for explaining an example of processing performed by a weight calculation unit 254. FIG. 12 illustrates an example of simulation results. FIG. 13 is a diagram for explaining an example of processing performed by a data conversion unit 255 and an inverse conversion unit 256. FIG. 14 is a block diagram illustrating a configuration example of the drive device 300. FIG. 15 illustrates an example of evaluation. FIGS. 16 and 17 are flowcharts illustrating examples of operation of the computing device 200. FIG. 18 is a flowchart illustrating an example of operation of the drive device 300.

The first example embodiment of the present disclosure describes the control system 100 including the computing device 200 and the drive device 300, as illustrated in FIG. 1. In the case of the present embodiment, the computing device 200 performs main component analysis after performing simulations the sufficient number of times for each of the control input candidates, and then determines sample points and weights on the axis having the highest contribution rate, which will be described below. Moreover, when the drive device 300 performs drive control, the drive device 300 evaluates the evaluation function value by using the sample points and the weights determined by the computing device 200, and performs drive control based on the evaluation result.

Note that the present embodiment describes the case where the computing device 200 determines sample points and weights beforehand, and the result of determination by the computing device 200 is stored in advance in a storage device or the like included in the drive device 300, as an example. However, the computing device 200 and the drive device 300 may be configured to be communicable with each other during driving of the drive device 300, as described below. In other words, the computing device 200 and the drive device 300 may be configured to communicate with each other during driving or the like of the drive device 300 so that a result of determination by the computing device 200 is reflected during driving or the like of the drive device 300.

Moreover, as illustrated in FIG. 2, in the present embodiment, the drive device 300 is assumed to be a two-wheeled mobile robot that moves on a flat plane and is movable only in a direction that the drive device 300 faces. FIG. 2 shows that the drive device 300 is movable in a direction with a circle that is a direction that the drive device 300 faces, while the drive device 300 is unmovable in a direction with an x mark that is a direction different from the direction that the drive device 300 faces, such as a lateral direction. For example, the velocity v and the angular velocity ω can be input to the drive device 300. In other words, the control inputs in the present embodiment include values representing the velocity v and the angular velocity ω. The control inputs may include information representing the time to be driven and the like. Moreover, the state of the drive device 300 is defined by the position (x, y) and the orientation θ that the drive device 300 faces. As an example, the drive device 300 is driven with a motion model as described in Non-Patent Literature 1.

However, the present invention is applicable without being limited to a two-wheeled mobile robot as described above. For example, the drive device 300 may be configured to be movable in a direction other than the direction that it faces such as a lateral direction, or may be movable in three-dimensional directions. Moreover, the drive device 300 may be a robot of any other type such as a robot arm. In the case where the drive device 300 is one other than the two-wheeled mobile robot as described above, the contents of the control inputs to the drive device 300 and the state of the drive device 300 may be determined according to the moving method or the like of the robot to which the present invention is applied. For example, control inputs such as an x-axis direction velocity, a y-axis direction velocity, and rotational torque may be input to the drive device 300 in place of the angular velocity or in addition to the angular velocity, and the position indicating the state of the drive device 300 may include the z coordinate in addition to the x coordinate and the y coordinate.

The control system 100 is a system that controls driving of the drive device 300. As illustrated in FIG. 1, the control system 100 includes the computing device 200 and the drive device 300, for example.

Referring to FIG. 1, the computing device 200 and the drive device 300 may be connected so as to be communicable with each other over a network or the like, for example. The computing device 200 and the drive device 300 may be connected to be communicable with each other in a wired manner or may be connected to be communicable with each other in a wireless manner.

The computing device 200 is an information processing device that determines a value to be used for evaluating control input candidates to be input to the drive device 300. For example, the computing device 200 determines sample points and weights selected based on a plurality of simulation results, as values to be used for evaluating Expression 2 used for evaluating the control input candidates.

$$\int f ( x ) p ( x ) dx \qquad [ Expression 2 ]$$

In Expression 2, x represents the state of a robot such as a position and orientation of the robot, and f(x) represents a function for evaluating the state. Further, p(x) represents the probability density that takes the state x.

FIG. 3 illustrates a configuration example of the computing device 200. Referring to FIG. 3, the computing device 200 includes an operation input unit 210, a screen display unit 220, a communication interface (I/F) unit 230, a storage unit 240, and an arithmetic processing unit 250, for example, as main constituent elements.

FIG. 3 illustrates the case of implementing the function of the computing device 200 by using one information processing device, as an example. However, the computing device 200 may be realized by using a plurality of information processing devices, for example, on the cloud. The computing device 200 may not include part of the above-mentioned constituent elements such as not including the operation input unit or the screen display unit, or may include a constituent element other than those described above.

The operation input unit 210 is configured of operation input devices such as a keyboard and a mouse. The operation input unit 210 detects operation by an operator who operates the computing device 200, and outputs it to the arithmetic processing unit 250.

The screen display unit 220 is a screen display device such as a liquid crystal display (LCD). The screen display unit 220 can display, on the screen, various types of information stored in the storage unit 240, in response to an instruction from the arithmetic processing unit 250.

The communication I/F unit 230 is configured of a data communication circuit or the like. The communication I/F unit 230 performs data communication with external devices such as the drive device 300 connected over a communication network.

The storage unit 240 is a storage device such as a hard disk or a memory. The storage unit 240 stores therein processing information and a program 244 required for various types of processing performed in the arithmetic processing unit 250. The program 244 is read and executed by the arithmetic processing unit 250 to thereby implement various processing units. The program 244 is read in advance from an external device or a storage medium via a data input/output function of the communication I/F unit 230 and the like, and is stored in the storage unit 240. The main information stored in the storage unit 240 includes, for example, the control input candidate information 241, the simulation result information 242, the sample point information 243, and the like.

The control input candidate information 241 represents control input candidates that may be input to the drive device 300. For example, the control input candidate information 241 includes all control input candidates that may be input to the drive device 300 when the state of the drive device 300 is at the reference point (for example, x=0, y=0, θ=0). The control input candidate information 241 may include only partial control input candidates extracted by any method among all control input candidates that may be input. For example, the control input candidate information 241 is acquired in advance by using a method of acquiring it from an external device via the communication I/F unit 230 or inputting it using the operation input unit 210, and is stored in the storage unit 240.

FIG. 4 illustrates an example of the control input candidate information 241. Referring to FIG. 4, the control input candidate information 241 includes a plurality of combinations of the velocity v and the angular velocity ω that are control input candidates that may be input to the drive device 300. For example, in the case of FIG. 4, m pieces of combinations of the velocity v and the angular velocity ω such as (v¹, ω¹), . . . (v^{m}, ω^{m}) are included. Note that “m” may take any value.

The simulation result information 242 represents a result of simulating a driving result of the drive device 300 by a simulation execution unit 251 to be described below. For example, the simulation result information 242 shows the simulation result indicating the state of the drive device 300 after the driving for each control input candidate, in the case where the control input candidates represented by the control input candidate information 241 are input. The simulation result information 242 also includes information showing a plurality of simulation results in which the time of driving the drive device 300 is different such as one second later, two seconds later, and three seconds later. The simulation result information 242 may include only information showing the simulation result of the case where the drive device 300 has been driven an arbitrary time such as 0.5 seconds later. For example, the simulation result information 242 is updated in response to execution of simulation by the simulation execution unit 251.

As described below, the simulation execution unit 251 executes simulations a plurality of times for each control input candidate shown by the control input candidate information 241. For example, the simulation execution unit 251 executes simulations a plurality of times until a predetermined condition is satisfied. Moreover, in the case of the present embodiment, the simulation execution unit 251 executes simulations in an uncertain system. Therefore, when the simulations are executed a plurality of times, the solution orbit varies each time at random. As a result, the simulation result information 242 includes a plurality of pieces of information representing the state of the drive device 300, showing the position (x, y) and the orientation of the drive device 300 after the driving which are specified as simulation results. For example, FIG. 5 illustrates state distribution examples after the drive device 300 is driven one second, which are specified after execution of simulations a plurality of times by the simulation execution unit 251 for a control input candidate. In the example illustrated in FIG. 5, each circle represents a state of the drive device 300 after the driving. That is, in FIG. 5, one circle corresponds to information representing the position (x, y) and the orientation θ of the drive device 300 after the driving, although illustration of θ is omitted. The simulation result information 242 includes information showing the state of the drive device 300 corresponding to each of the circles illustrated in FIG. 5, for example.

As described above, the simulation result information 242 includes information representing the state of the drive device 300 for each control input candidate. Moreover, the simulation result information 242 may also include information representing a plurality of simulation results in which the time of driving the drive device 300 is different. In other words, the simulation result information 242 may include information representing the state of the drive device 300 corresponding to each state distribution, corresponding to the control input candidate and the time that the drive device 300 is driven.

The sample point information 243 includes information representing sample points selected based on the simulation result information 242 by the sample point selection unit 253 to be described below. Here, a sample point corresponds to one state of the drive device 300 specified as a result of simulation by the simulation execution unit 251. In other words, in the case of the present embodiment, a sample point includes information representing the position (x, y) and the orientation θ of the drive device 300. The sample point information 243 also includes information representing the weight of a sample point calculated by the weight calculation unit 254 to be described below. For example, the sample point information 243 is updated in response to selection of a sample point by the sample point selection unit 253, calculation of a weight corresponding to a sample point by the weight calculation unit 254, execution of inverse conversion by the inverse conversion unit 256, and the like.

FIG. 6 illustrates an example of information included in the sample point information 243. Referring to FIG. 6, the sample point information 243 includes information indicating sample points and weights for each control input candidate. In other words, in the sample point information 243, information representing a control input candidate and information representing sample points and weights that are values to be used for evaluating the control input candidate are associated with each other. For example, referring to FIG. 6, the sample point information 243 includes information representing n pieces of sample points and weights corresponding to the respective sample points, when a control input candidate is (v¹, ω¹). Similarly, the sample point information 243 includes information representing sample points and weights corresponding to each candidate up to a control input candidate (v^{m}, ω^{m}). Note that n in FIG. 6 represents a value corresponding to the number of sample points, and n may take any value.

As described above, the simulation result information 242 may include information representing the state of the drive device 300 corresponding to each state distribution, corresponding to the time that the drive device 300 has been driven. As similar to the case of the simulation result information 242, the sample point information 243 may include information representing the sample points and the weights corresponding to each control input candidate, for each time that the drive device 300 is driven during simulation.

The arithmetic processing unit 250 includes an arithmetic unit such as a central processing unit (CPU) and the peripheral circuits thereof. The arithmetic processing unit 250 reads, from the storage unit 240, and executes the program 244 to implement various processing units through cooperation between the hardware and the program 244. The main processing units to be realized by the arithmetic processing unit 250 includes, for example, the simulation execution unit 251, the main component analysis execution unit 252, the sample point selection unit 253, the weight calculation unit 254, the data conversion unit 255, the inverse conversion unit 256, the output unit 257, and the like. As describe below, the sample point selection unit 253 and the calculation unit 254 perform processing to determine sample points and weights that are values to be used for evaluating control input candidates. Therefore, it can be said that the sample point selection unit 253 and the weight calculation unit 254 constitute a determination unit that determines the values.

The simulation execution unit 251 simulates a state of the drive device 300 after driving the drive device 300 a predetermined time, for each control input candidate shown by the control input candidate information 241. For example, the simulation execution unit 251 executes simulations a plurality of times until a predetermined condition is satisfied, for each control input candidate. The simulation execution unit 251 may also perform a plurality of types of simulation in which the time of driving the drive device 300 is different. In the case of the present embodiment, the simulation execution unit 251 executes simulations in an uncertain system. Therefore, when the simulations are executed a plurality of times, the solution orbit varies each time at random. Moreover, the simulation execution unit 251 stores the information representing the state of the drive device 300 specified as a result of simulation, in the storage unit 240 as the simulation result information 242.

For example, the simulation execution unit 251 simulates a state of the drive device 300 of the case of using a motion model as illustrated by Expression 16 in Non-Patent Literature 1. As illustrated in FIG. 5, the simulation execution unit 251 specifies a plurality of states of the drive device 300 after the driving, by executing simulations a plurality of times, for each control input candidate. Note that in Expression 16 in Non-Patent Literature 1, rω(t) corresponds to the velocity v described above. Moreover, I represents an inter-wheel distance.

In addition, in Expression 16 in Non-Patent Literature 1, D represents the scale of dispersion. Here, the scale of dispersion may be determined by any method, for example. For example, the scale of dispersion may be determined in advance, or may be determined according to the environment of the site where the drive device 300 is actually driven.

Note that the motion model to be used for simulation by the simulation execution unit 251 is not limited to that illustrated above. The simulation execution unit 251 may be configured to execute simulations by using a known motion model other than that illustrated above. Moreover, while the present embodiment illustrates the case where the drive device 300 is a two-wheeled mobile robot, the drive device 300 may be a device other than a two-wheel moving rotor, as described above. In the case where the drive device 300 is other than a two-wheeled mobile robot, the motion model to be used for simulation by the simulation execution unit 251 may be one corresponding to the type or the like of the drive device 300.

The main component analysis execution unit 252 (analysis unit) performs main component analysis on the state distribution for each control input candidate or each driving time represented by the simulation result information 242, and selects a main component axis in which the distribution width is the largest. For example, the main component analysis execution unit 252 executes processing to draw a main component axis for each state distribution such that variations of states (state data) in the state distribution becomes the largest.

FIG. 7 is a diagram for explaining processing performed by the main component analysis execution unit 252. As illustrated in FIG. 7, the main component analysis execution unit 252 performs main component analysis to select a linear main component axis in which the dispersion width becomes the largest as an example in the state distribution.

Note that in the present embodiment, the main component analysis execution unit 252 selects an axis having a large dispersion width, that is, a first main component axis, as an example. However, the main component analysis execution unit 252 may select a second main component axis in which the dispersion width is the second largest, in addition to the first main component axis, corresponding to the condition of the state distribution such as the shape of the state distribution, for example. Similarly, the main component analysis execution unit 252 may be configured to select a plurality of axes such as a third main component axis, a fourth main component axis, and the like, corresponding to any conditions or the like.

Moreover, as an example, in the case where the drive device 300 is a robot that is freely movable in a three-dimensional space, the state of the drive device 300 includes three dimensions of position and three dimensions of orientation (roll, pitch, yaw), that is, information of six dimensions. In that case, when only a first component axis is selected to have only one dimension, there is a possibility that a large amount of information is missing. Therefore, the main component analysis execution unit 252 may be configured to select a plurality of axes according to the type of the drive device 300. For example, the main component analysis execution unit 252 may be configured to select the number of axes to be selected, according to the conditions such as state distribution and the type of the drive device 300, as described above.

The sample point selection unit 253 selects sample points that satisfy the given condition from among the state data on the main component axis. For example, the sample point selection unit 253 selects sample points per state distribution, that is, for each control input candidate or each driving time. Moreover, the sample point selection unit 253 stores information representing the state of the drive device 300 corresponding to the selected sample points, in the storage unit 240 as the sample point information 243.

For example, the sample point selection unit 253 projects the state data to the main component axis. Then, the sample point selection unit 253 selects points corresponding to −kσ to +kσ as sample points, where a represents the standard deviation of the state data projected to the axial direction. For example, FIG. 8 illustrates an example of selection processing by the sample point selection unit 253 when k is 3. Referring to FIG. 8, for example, the sample point selection unit 253 selects points of state data corresponding to −3σ, −2σ, −σ, 0, σ, 2σ, and 3σ respectively, as sample data, among points corresponding to the state data on the main component axis. Note that k may take any value.

For example, as described above, sample points on the main component analysis execution unit are selected by the main component analysis execution unit 252 and the sample point selection unit 253 from the state distribution as illustrated in FIG. 9. This means that the main component analysis execution unit 252 and the sample point selection unit 253 select points satisfying the predetermined condition on the main component analysis axis indicating the state distribution most, from among the points of state data included in the state distribution, as sample points.

Note that the main component analysis execution unit 252 may select a plurality of axes as described above. In that case, the sample point selection unit 253 may select sample points from the data points on a plurality of axes, or may select sample points from a partial space drawn by the direction vectors of the first main component axis and the second main component axis (or more), for example. The means for selecting sample points by the sample point selection unit 253 may be determined by any method.

The weight calculation unit 254 calculates the weight corresponding to the sample point selected by the sample point selection unit 253. For example, a weight shows the value corresponding to the distribution of state data on the main component axis. The weight calculation unit 254 also stores the information representing the calculated weight in the storage unit 240 as the sample point information 243.

For example, the weight calculation unit 254 assumes that distribution of the state data points projected in the axial direction by the sample point selection unit 253 is normal distribution, and calculates the weight corresponding to the sample point by integrating the distribution of the state data within the range illustrated in FIG. 10. That is, the weight calculation unit 254 calculates the weight corresponding to each sample point by integrating each sample point in the range corresponding to the sample point, on the basis of distribution of the state data points projected in the axis direction by the sample point selection unit 253. Note that FIG. 10 illustrates the case where k is 3. When k takes a value other than 3, the integration range may also be that corresponding to the value of k.

The weight calculation unit 254 may also calculate the weight on the basis of the number of state data points. For example, as illustrated in FIG. 11, the weight calculation unit 254 counts the number of state data points (that is, the number of states) that fall within the section divided at the intermediate point of each sample point, on the basis of distribution of the state data points projected in the axial direction by the sample point selection unit 253. Then, the weight calculation unit 254 calculates the counted number of state data points as the weight.

For example, the weight calculation unit 254 calculates the weight corresponding to each sample point selected by the sample point selection unit 253 by using any of the methods described above as examples. The weight calculation unit 254 may calculate the weight corresponding to the state distribution by using a method other than that illustrated above.

The computing device 200 determines sample points and weights by the method as described above, for example. According to the method as described above, the sample points are placed on the linear main component axis. Therefore, in the case of curved state distribution as illustrated in FIG. 12, the above-described method may not be suitable.

Accordingly, as illustrated in FIG. 13, the computing device 200 can convert the state distribution into linear data distribution by using the data conversion unit 255, and select sample points on the main component analysis axis in the converted state by the main component analysis execution unit 252 and the sample point selection unit 253. As an example, Non-Patent Literature 2 describes a coordinate conversion method for a robot on a two-dimensional plane. For example, the data conversion unit 255 may perform non-linear conversion by a method as described in Non-Patent Literature 2 to convert the state distribution in the curved form as a whole into a linear form. Further, after the selection of the sample points, the inverse conversion unit 256 performs processing opposite to that performed by the conversion unit 255 to thereby performs inverse conversion on the whole linear form into the original curved state distribution. As a result, the computing device 200 can select sample points in an appropriate form corresponding to the curved state distribution. Note that the data conversion unit 255 may be configured to use a wall-known method other than that described as an example, to convert the state distribution in a form not suitable for selecting sample points into a form suitable for selecting sample points by the main component analysis execution unit 252 and the sample point selection unit 253.

Note that whether or not to perform processing by the date conversion unit 255 and the inverse conversion unit 256 may be determined by any method. For example, the computing device 200 may be configured to select sample points for both the case of not performing the processing and the case of performing the processing by the data conversion unit 255 and the inverse conversion unit 256, and adopt a selection result that can be evaluated to be more suitable such as a selection result in which the selected number of sample points is more appropriate. For example, the computing device 200 may be configured to perform processing by the data conversion unit 255 and the inverse conversion unit 256 in the case where a predetermined number of sample points were not extracted in the case where processing was not performed by the data conversion unit 255 and the inverse conversion unit 256. The computing device 200 may be configured to perform processing by the data conversion unit 255 and the inverse conversion unit 256 in the case where the state distribution satisfies or does not satisfy a predetermined condition. The computing device 200 may be configured to determine whether or not to perform processing by the data conversion unit 255 and the inverse conversion unit 256 on the basis of a condition other than those illustrated above.

The output unit 257 outputs the sample point information 243 and the like. For example, the output unit 257 displays information stored in the storage unit 240 such as the sample point information 243 on the screen display unit 220, or transmits it to an external device such as the drive device 300 via the communication I/F unit 230.

The drive device 300 is a robot that evaluates a control input candidate by using sample points, weights, and the like determined by the computing device 200, and drives according to the evaluation result. As described above, in the present embodiment, the drive device 300 is a two-wheeled mobile robot that moves on a flat plane and is movable only in a direction that the drive device 300 faces. The drive device 300 may be one other than that illustrated above.

FIG. 14 illustrates a configuration example of the drive device 300. Referring to FIG. 14, the drive device 300 includes, for example, a communication I/F unit 310, a storage unit 320, and an arithmetic processing unit 330, as main constituent elements.

The communication I/F unit 310 is configured of a data communication circuit or the like. The communication I/F unit 310 performs data communication with external devices such as the computing device 200 connected over a communication network.

The storage unit 320 is a storage device such as a hard disk or a memory. The storage unit 320 stores therein processing information and a program 323 required for various types of processing performed in the arithmetic processing unit 330. The program 323 is read and executed by the arithmetic processing unit 330 to thereby implement various processing units. The program 323 is read in advance from an external device or a storage medium via a data input/output function of the communication I/F unit 310 and the like, and is stored in the storage unit 320. The main information stored in the storage unit 320 includes, for example, control input candidate information 321, sample point information 322, and the like.

The control input candidate information 321 represents control input candidates that may be input to the drive device 300. The control input candidate information 321 includes at least part of control input candidates included in the control input candidate information stored in the computing device 200. For example, the control input candidate information 321 is acquired in advance from an external device such as the computing device 200 via the communication I/F unit 310, and is stored in the storage unit 320.

The sample point information 322 includes information representing sample points selected based on the simulation result information 242 by the sample point selection unit 253, as similar to the sample point information 243 held by the computing device 200. For example, in the sample point information 322, information indicating a control input candidate and information indicating sample points and weights that are values to be used for evaluating the control input candidate are associated with each other. The sample point information 322 includes at least part of the sample points and weights included in the sample point information 243 stored in the computing device 200. For example, the sample point information 322 is acquired in advance from an external device such as the computing device 200 via the communication I/F unit 310, and is stored in the storage unit 320.

The arithmetic processing unit 330 includes an arithmetic unit such as a CPU and its peripheral circuits. The arithmetic processing unit 330 reads, from the storage unit 320, and executes the program 323 to implement various processing units through cooperation between the hardware and the program 323. Main processing units to be realized by the arithmetic processing unit 330 include, for example, a sample point extraction unit 331, an evaluation value estimation unit 332, a selection unit 333, and a driving unit 334.

The sample point extraction unit 331 extracts sample points corresponding to the control input subjected to evaluation, on the basis of the sample point information 322 and the like. For example, the sample point extraction unit 331 extracts sample points and weights corresponding to a control input candidate that may be input to the drive device 300.

For example, the sample point extraction unit 331 specifies a control input candidate that may be input on the basis of the state of the robot. The sample point extraction unit 331 may specify a control input candidate that may be input by using any method, such as specifying a control input candidate that may be input according to the contents of control such as a target point or a desired moving direction input from an external device or the like. The sample point extraction unit 331 also extracts sample points and weights corresponding to the specified control input candidate, with reference to the sample point information 322. For example, the sample point extraction unit 331 can extract sample points and weights corresponding to a plurality of candidates.

The evaluation value estimation unit 332 estimates an evaluation value corresponding to each control input candidate that may be input, on the basis of the sample points and weights extracted by the sample point extraction unit 331.

For example, the evaluation value estimation unit 332 estimates the evaluation value corresponding to each control input candidate, on the basis of a state of the drive device 300 such as a position (x, y) and orientation θ, the sample points and weights extracted by the sample point extraction unit 331, and the like. As an example, when evaluating a control input candidate (v^{m}, ω^{m}), the evaluation value estimation unit 332 approximately evaluates Expression 2 by using Expression 3.

$$\int f ( x ) p ( x ) dx \approx \frac{{\sum }_{j = 1}^{n} f ( {x}_{i} + {x}_{j}^{m} ) {{\tilde{p}}_{j}^{m}}^{}}{{\sum }_{j = 1}^{n} {\tilde{p}}_{j}^{m}} \qquad [ Expression 3 ]$$

Note that xᵢ in Expression 3 represents the state of the drive device 300. Further, x^{m} represents the value of a sample point, p^{m} represents the weight value, and j takes a value from 1 to n. Note that m becomes a value corresponding to the control input candidate subjected to evaluation.

The selection unit 333 selects a control input to be input actually, from among control input candidates that may be input, on the basis of the evaluation result by the evaluation value estimation unit 332. For example, the selection unit 333 compares the evaluation results corresponding to the respective control input candidates, and selects a control input candidate corresponding to the most desired evaluation value as a control input candidate to be input actually.

For example, for all or part of the control input candidates, the selection unit 333 compares evaluation results obtained with respect to the respective control input candidates, and selects a control input candidate to which the maximum evaluation value is given (when the evaluation function is defined as a loss, minimum), as a control input to be input actually. For example, in the case where two patterns of velocities including a low speed (0, 1) and a high speed (1, 0) and three patterns of angular velocities including left turn (0, 3), straight (0), and right turn (0, 3) are control input candidates, the patterns of combinations of all velocities and angular velocities are two by three, that is, six patterns. Therefore, the selection unit 333 compares the evaluation results obtained by the evaluation value estimation unit 332 with respect to the respective inputs of six patterns, and selects a control input candidate to which the maximum evaluation value is given, as a control input. The selection unit 333 may be configured to select a more desirable control input candidate as a control input to be input actually, by using a method other than that illustrated above.

The driving unit 334 actually drives the drive device 300 on the basis of a result of selection by the selection unit 333. In other words, the driving unit 334 drives the drive device 300 during the time corresponding to the control input with the velocity v and the angular velocity ω corresponding to the control input selected by the selection unit 333.

The configuration example of the drive device 300 is as described above.

Here, FIG. 15 illustrates an example of an evaluation value corresponding to a control input selected in the present disclosure. Specifically, FIG. 15 illustrates an example of a correct value and an evaluation value in the case where 0.5 is input as a value of the velocity v and 0 is input as a value of the angular velocity ω. In addition, as a comparison example of the present disclosure, FIG. 15 illustrates an estimation value estimated by the Monte Carlo method in the case of using the number of Monte Carlo samples. In the case of using the Monte Carlo method, variation is made in a degree that the size of an error bar illustrated in FIG. 15 is the standard deviation. As illustrated in FIG. 15, the degree of variation becomes larger as the number of Monte Carlo samples is smaller. In particular, in the case where the number of samples is seven as illustrated in the present disclosure as an example, it is found that the variation becomes very large. On the other hand, according to the method described in the present disclosure, it is found that a value close to the correct value can be estimated with high accuracy.

Next, an example of operation of the computing device 200 and the drive device 300 will be described with reference to FIGS. 16 to 18. First, an example of operation of the computing device 200 will be described with reference to FIGS. 16 and 17.

FIG. 16 is a flowchart illustrating an example of operation of the computing device 200. Referring to FIG. 16, the simulation execution unit 251 simulates a state of the drive device 300 after driving the drive device 300 a predetermined period of time, for each control input candidate represented by the control input candidate information 241 (step S101). For example, the simulation execution unit 251 executes simulations a plurality of times until a predetermined condition is satisfied, for each control input candidate. The simulation execution unit 251 may also perform a plurality of types of simulations in which the time of driving the drive device 300 is different.

The main component analysis execution unit 252 performs main component analysis on the state distribution for each control input candidate or each driving time, on the basis of a simulation result by the simulation execution unit 251, and selects a main component axis in which the distribution width is the largest (step S102).

The sample point selection unit 253 selects a sample point that satisfies the given condition from the state data on the main component axis (step S103). For example, the sample point selection unit 253 selects a sample point per state distribution, that is, for each control input candidate or each driving time.

The weight calculation unit 254 calculates the weight of the sample point selected by the sample point selection unit 253 (step S104). For example, the weight calculation unit 254 calculates the weight corresponding to each sample point corresponding to the distribution of state data on the main component axis.

The sample point selection unit 253 stores the selected sample point in the storage unit 240. The weight calculation unit 254 stores the calculated weight in the storage unit 240 (step S105). The processing of step S105 may be performed after each processing of steps S103 and S104.

For example, the computing device 200 determines the sample point and the weight by the operation as described above. The information representing the sample point and the weight determined by the computing device 200 can be output to the drive device 300 or the like at any timing, for example.

FIG. 17 is a flowchart illustrating another example of operation of the computing device 200. Referring to FIG. 17, the data conversion unit 255 performs non-linear conversion by any method after the processing of step S101, to convert the state distribution in the curved form as a whole into a linear form (step S201).

After the processing of step S201, the processing of steps from S102 to S104 is performed. After the processing of step S104, the inverse conversion unit 256 performs processing opposite to that performed by the data conversion unit 255 to thereby perform inverse conversion on the linear form as a whole into the original curved state distribution (step S202). Thereafter, the inverse conversion unit 256 stores the sample point corresponding to the original curved state distribution caused by the inverse conversion, in the storage unit 240 (step S203).

As described above, which of the processing illustrated in FIG. 16 and the processing illustrated in FIG. 17 the computing device 200 performs may be selected by any method. The computing device 200 may be configured to perform both the processing illustrated in FIG. 16 and the processing illustrated in FIG. 17. In that case, which of the processing result of FIG. 16 and the processing result of FIG. 17 the computing device 200 adopts may be determined by any method.

Next, an example of operation of the drive device 300 will be described with reference to FIG. 18. FIG. 18 is a flowchart illustrating an example of operation of the drive device 300. Referring to FIG. 18, the sample point extraction unit 331 extracts sample points corresponding to the control input subjected to evaluation, on the basis of the sample point information 322 and the like (step S301). For example, the sample point extraction unit 331 extracts sample points and weights corresponding to the control input candidate that may be input to the drive device 300.

The evaluation value estimation unit 332 estimates an evaluation value corresponding to each control input candidate that may be input, on the basis of the sample points and weights extracted by the sample point extraction unit 331 (step S302). For example, the evaluation value estimation unit 332 estimates an evaluation value corresponding to each control input candidate, on the basis of a state of the drive device 300 such as a position (x, y) and orientation θ, the sample points and weights extracted by the sample point extraction unit 331, and the like.

The selection unit 333 selects a control input to be input actually from among the control input candidates that may be input, on the basis of the evaluation result by the evaluation value estimation unit 332 (step S303). The selection unit 333 may select a control input corresponding to the most desirable evaluation value by any method.

The driving unit 334 actually drives the drive device 300 on the basis of a result of selection by the selection unit 333 (step S304). As a result, the drive device 300 operates according to the selection by the selection unit 333.

The example of operation of the drive device 300 is as described above.

As described above, the computing device 200 includes the simulation execution unit 251, the main component analysis execution unit 252, and the sample point selection unit 253. According to such a configuration, the sample point selection unit 253 can select sample points that are state data satisfying a predetermined condition, from among state data on a main component axis that is selected by the main component analysis execution unit 252 on the basis of the simulation result by the simulation execution unit 251. As a result, the drive device 300 can estimate the evaluation value based on the sample points selected by the sample point selection unit 253. Accordingly, the drive device 300 can evaluate the control input candidate with higher accuracy, so that it is possible to improve the control accuracy.

Moreover, according to the method described in the present embodiment, estimation by the drive device 300 is performed by using sample points and the like determined by the computing device 200 in advance. By using such a previous computation result, it is possible to suppress computation cost for actually evaluating the control input candidate. As a result, it is possible to evaluate the control input candidate with higher accuracy at a higher speed.

Note that in the present embodiment, the computing device 200 determines sample points and weights beforehand, and the determination result by the computing device 200 is stored in advance in a storage device or the like included in the drive device 300. However, the computing device 200 and the drive device 300 may be configured to be communicable with each other during driving of the drive device 300, as described above. For example, the computing device 200 may be configured to perform processing such as execution of simulations and selection of sample points during driving of the drive device 300, and transmit update information of the sample point information 322 based on the processing result to the drive device 300. In that case, when evaluating a new control input candidate or the like, the drive device 300 may be configured to perform evaluation based on the sample point information 322 updated according to the received update information.

Moreover, the configuration of the control system 100 is not limited to the case illustrated in the present disclosure as an example. For example, at least part of the function held by the computing device 200 may be held by the drive device 300. For example, in the case where the drive device 300 includes all functions as the computing device 200, the control system 100 may not include the computing device 200.

### Second Example Embodiment

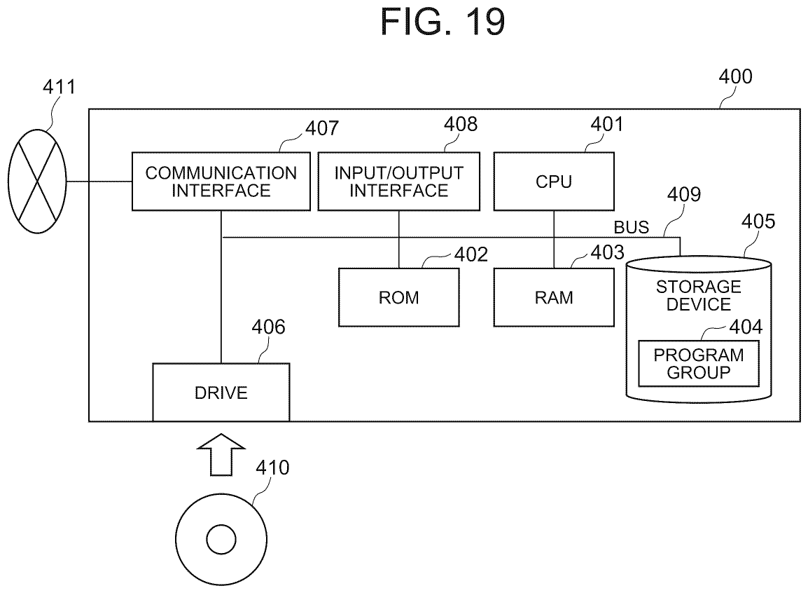

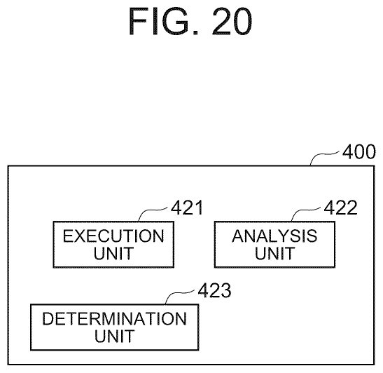

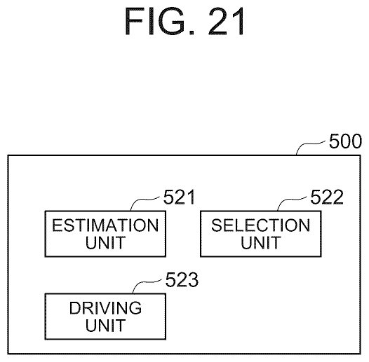

Next, a second example embodiment of the present disclosure will be described with reference to FIGS. 19 to 21. FIG. 19 is a diagram illustrating an example of a hardware configuration of a computing device 400. FIG. 20 is a block diagram illustrating a configuration example of the computing device 400. FIG. 21 is a block diagram illustrating a configuration example of a drive device 500.

The second example embodiment of the present disclosure describes the computing device 400 that is an information processing device that determines a value to be used for evaluating a control input candidate, on the basis of a value of a control input that may be input to the drive device. The second example embodiment also describes the drive device 500 that performs evaluation using the value determined by the computing device 400 and performs selection based on the evaluation result.

FIG. 19 illustrates an example of a hardware configuration of the computing device 400. Referring to FIG. 19, the computing device 400 has a hardware configuration as described below, as an example.
Central Processing Unit (CPU) 401 (arithmetic device)
Read Only Memory (ROM) 402 (storage device)
Random Access Memory (RAM) 403 (storage device)
Program group 404 to be loaded to the RAM 403
Storage device 405 storing therein the program group 404
Drive 406 that performs reading and writing on a storage medium 410 outside the information processing device
Communication interface 407 connecting to a communication network 411 outside the information processing device
Input/output interface 408 for performing input/output of data
Bus 409 connecting the respective constituent elements

Further, the computing device 400 can implement functions as an execution unit 421, an analysis unit 422, and a determination unit 423 illustrated in FIG. 20 through acquisition of the program group 404 by the CPU 401 and execution by the CPU 401. Note that the program group 404 is stored in the storage device 405 or the ROM 402 in advance for example, and is loaded to the RAM 403 or the like by the CPU 401 as needed. Further, the program group 404 may be provided to the CPU 401 via the communication network 411, or may be stored on the storage medium 410 in advance and read out by the drive 406 and supplied to the CPU 401.

FIG. 19 illustrates an example of a hardware configuration of the computing device 400. The hardware configuration of the computing device 400 is not limited to that described above. For example, the computing device 400 may be configured of part of the configuration described above, such as without the drive 406.

The execution unit 421 simulates the state of the drive device after the drive device is driven in response to a control input, on the basis of a value of the control input that may be input to the drive device. Note that the state of the drive device may include information representing the position and orientation of the drive device.

The analysis unit 422 selects a main component axis by performing main component analysis on the state distribution of the drive device that is specified through simulations performed a plurality of times by the execution unit 421.

The determination unit 423 determines a value to be used for evaluating a control input candidate to be input to the drive device, on the basis of the selection result by the analysis unit 422. For example, the determination unit 423 determines sample points and weights as values to be used for evaluating the control input candidate.

As described above, the computing device 400 includes the execution unit 421, the analysis unit 422, and the determination unit 423. According to such a configuration, the determination unit 423 can determine a value to be used for evaluating the control input candidate, on the basis of the selection result by the analysis unit 422 with use of the simulation result by the execution unit 421. As a result, the drive device can perform evaluation using the value determined by the determination unit 423. Thereby, it is possible to improve the control accuracy. Moreover, according to the configuration described above, the drive device can perform evaluation by using a predetermined value. As a result, evaluation can be performed at a higher speed.

Note that the computing device 400 described above can be realized by incorporation of a predetermined program in an information processing device such as the computing device 400. Specifically, a program that is another aspect of the present invention is a program for causing an information processing device such as the computing device 400 to execute processing to simulate the state of a drive device after the drive device is driven according to a control input on the basis of a value of the control input that can be input to the drive device, select a main component axis by performing main component analysis on the state distribution of the drive device specified by performing simulations a plurality of times, and on the basis of the selection result, determine a value to be used for evaluating a control input candidate to be input to the drive device.

Further, a determination method to be executed by an information processing device such as the computing device 400 includes, by an information processing device such as the computing device 400, simulating the state of a drive device after the drive device is driven according to a control input on the basis of a value of the control input that can be input to the drive device, selecting a main component axis by performing main component analysis on the state distribution of the drive device specified by performing simulations a plurality of times, and on the basis of the selection result, determining a value to be used for evaluating a control input candidate to be input to the drive device.

Even a program, a computer-readable storage medium storing thereon a program, or a determination method having the above-described configuration also exhibits the same actions and effects as those of the computing device 400. Therefore, the above-described object of the present invention can also be achieved.

Moreover, an object of the present invention can be achieved by the drive device 500 including an estimation unit 521 and a selection unit 522. For example, the drive device 500 can have a configuration that is similar to the hardware configuration held by the computing device 400 described with reference to FIG. 19. For example, the drive device 500 can implement functions as the estimation unit 521 and the selection unit 522 illustrated in FIG. 21 through acquisition of the program group by the CPU and execution by the CPU, as similar to the case of the computing device 400. As similar to the case of the computing device 400, for the hardware configuration of the drive device 500, various modifications may be adopted without being limited to the case illustrated in FIG. 19.

The estimation unit 521 estimates an evaluation value corresponding to a control input candidate on the basis of a value to be used for evaluating the control input candidate to be input to the drive device determined on the basis of the result of main component analysis with respect to the simulation result using the value of the control input that can be input to the drive device, and the state of the drive device. For example, the value to be used for evaluating a control input candidate is determined in advance by an external device or the like such as the computing device 400.

The selection unit 522 selects a control input to be input actually from among the control input candidates, on the basis of the estimation result by the estimation unit 521. The selection unit 522 may perform the selection by using any method.

The driving unit 523 drives the own device on the basis of a selection result by the selection unit 522.

As described above, the drive device 500 includes the estimation unit 521, the selection unit 522, and the driving unit 523. With such a configuration, the selection unit 522 can select a control input to be input actually from among the control input candidates, on the basis of the estimation result by the estimation unit 521. Further, the driving unit 523 can drive the own device on the basis of the selection result by the selection unit 522. As a result, it is possible to improve the control accuracy.

Note that the driving device 500 described above can be realized by incorporation of a predetermined program in an information processing device such as the drive device 500. Specifically, a program that is another aspect of the present invention is a program for causing an information processing device such as the drive device 500 to estimate an evaluation value according to a control input candidate on the basis of a value to be used for evaluating the control input candidate to be input to the drive device that is determined based on a result of main component analysis performed with respect to a result of simulation using a value of a control input that can be input to the drive device, and the state of the drive device, and select a control input to be input actually from among a plurality of control input candidates.

Further, a driving method to be executed by an information processing device such as the drive device 500 includes estimating an evaluation value according to a control input candidate on the basis of a value to be used for evaluating the control input candidate to be input to the drive device that is determined based on a result of main component analysis performed on a result of simulation using a value of a control input that can be input to the drive device, and the state of the drive device, and on the basis of the estimation result, selecting a control input to be input actually from among a plurality of control input candidates.

Even a program, a computer-readable storage medium storing thereon a program, or a driving method having the above-described configuration also exhibits the same actions and effects as those of the drive device 500. Therefore, the above-described object of the present invention can also be achieved.

### <Supplementary Notes>

The whole or part of the example embodiments disclosed above can be described as the following supplementary notes. Hereinafter, the outlines of the computing device, the drive device, and the like of the present invention will be described. However, the present invention is not limited to the configurations described below.

### (Supplementary Note 1)

A computing device comprising:
an execution unit that simulates a state of a drive device after the drive device is driven according to a control input, on a basis of a value of the control input capable of being input to the drive device;
an analysis unit that selects a main component axis by performing main component analysis on state distribution of the drive device that is specified through simulations performed a plurality of times by the execution unit; and
a determination unit that determines a value to be used for evaluating a candidate for the control input to be input to the drive device, on a basis of a selection result by the analysis unit.

### (Supplementary Note 2)

The computing device according to supplementary note 1, wherein
the determination unit selects a plurality of sample points indicating the state of the drive device from states on the main component axis, as a value to be used for evaluating the candidate for the control input.

### (Supplementary Note 3)

The computing device according to supplementary note 2, wherein
the determination unit selects the sample points, and for each of the selected sample points, calculates a weight corresponding to distribution of the states on the main component axis.

### (Supplementary Note 4)

The computing device according to supplementary note 3, wherein
the determination unit calculates each of the sample points and the weight as values to be used for estimating an evaluation value corresponding to the candidate for the control input to be input to the drive device.

### (Supplementary Note 5)

The computing device according to any one of supplementary notes 1 to 4, wherein
the determination unit determines a value to be used for approximately evaluating Expression 1, as the value to be used for evaluating the candidate for the control input to be input to the drive device.

$$\int f ( x ) p ( x ) dx \qquad [ Expression 1 ]$$

### (Supplementary Note 6)

The computing device according to any one of supplementary notes 1 to 5, further comprising
a data conversion unit that performs predetermined conversion processing on the state distribution of the drive device that is specified through simulations performed a plurality of times by the execution unit, wherein
the analysis unit selects the main component axis on a basis of a conversion result by the data conversion unit.

### (Supplementary Note 7)

The computing device according to any one of supplementary notes 1 to 6, further comprising
an output unit that outputs the value determined by the determination unit to the drive device.

### (Supplementary Note 8)

A determination method comprising, by an information processing device:
simulating a state of a drive device after the drive device is driven according to a control input, on a basis of a value of the control input capable of being input to the drive device;
selecting a main component axis by performing main component analysis on state distribution of the drive device that is specified through simulations performed a plurality of times; and
determining a value to be used for evaluating a candidate for the control input to be input to the drive device, on a basis of a selection result.

### (Supplementary Note 9)

A computer-readable medium storing thereon a program for causing an information processing device to execute processing to:
simulate a state of a drive device after the drive device is driven according to a control input, on a basis of a value of the control input capable of being input to the drive device;
select a main component axis by performing main component analysis on state distribution of the drive device that is specified through simulations performed a plurality of times; and
determine a value to be used for evaluating a candidate for the control input to be input to the drive device, on a basis of a selection result.

### (Supplementary Note 10)

A drive device comprising:
an estimation unit that estimates an evaluation value corresponding to a candidate for a control input, on a basis of a value used for evaluating the candidate for the control input to be input to the drive device and on a basis of a state of the drive device, the value used for evaluating being determined on a basis of a result of main component analysis with respect to a simulation result using a value of the control input capable of being input to the drive device;
a selection unit that selects a control input to be actually input from among a plurality of the candidates for the control input on a basis of an estimation result by the estimation unit; and
a driving unit that drives the drive device on a basis of a selection result by the selection unit.

### (Supplementary Note 11)

The drive device according to supplementary note 10, further comprising:
a storage unit that stores information in which information representing a candidate for the control input and a value to be used for evaluating the candidate for the control input are associated with each other; and
an extraction unit that extracts a value corresponding to the candidate for the control input subjected to evaluation, from information stored in the storage unit, wherein
the estimation unit estimates the evaluation value on a basis of the value extracted by the extraction unit and the state of the drive device.

### (Supplementary Note 12)

The drive device according to supplementary note 11, wherein
a value determined previously by a computing device is acquired from the computing device and stored in the storage unit in advance, the computing device determining the value to be used for evaluating the candidate for the control input on a basis of the value of the control input capable of being input to the drive device.

### (Supplementary Note 13)

The drive device according to any one of supplementary notes 10 to 12, wherein
the value to be used for evaluating the candidate for the control input includes information representing a sample point indicating a state of the drive device and information representing a weight corresponding to the sample point.

### (Supplementary Note 14)

The drive device according to supplementary note 13, wherein
the estimation unit estimates the evaluation value by solving Expression 1 provided below, by using the sample point and the weight.

$$\int f ( x ) p ( x ) dx \approx \frac{{\sum }_{j = 1}^{n} f ( {x}_{i} + {x}_{j}^{m} ) {{\tilde{p}}_{j}^{m}}^{}}{{\sum }_{j = 1}^{n} {{\tilde{p}}_{j}^{m}}^{}} \qquad [ Expression 1 ]$$

### (Supplementary Note 15)

A driving method comprising, by a drive device,
estimating an evaluation value corresponding to a candidate for a control input, on a basis of a value used for evaluating the candidate for the control input to be input to the drive device and on a basis of a state of the drive device, the value used for evaluating being determined on a basis of a result of main component analysis with respect to a simulation result using a value of the control input capable of being input to the drive device;
selecting a control input to be actually input from among a plurality of the candidates for the control input on a basis of an estimation result; and
performing driving on a basis of a selection result.

### (Supplementary Note 16)

A computer-readable medium storing thereon a program for causing a drive device to execute processing to
estimate an evaluation value corresponding to a candidate for a control input, on a basis of a value used for evaluating the candidate for the control input to be input to the drive device and on a basis of a state of the drive device, the value used for evaluating being determined on a basis of a result of main component analysis with respect to a simulation result using a value of the control input capable of being input to the drive device;
select a control input to be actually input from among a plurality of the candidates for the control input, on a basis of an estimation result; and
perform driving on a basis of a selection result.

While the present invention has been described with reference to the exemplary embodiments described above, the present invention is not limited to the above-described embodiments. The form and details of the present invention can be changed within the scope of the present invention in various manners that can be understood by those skilled in the art.

### REFERENCE SIGNS LIST

100 control system
200 computing device
210 operation input unit
220 screen display unit
230 communication I/F unit
240 storage unit
241 control input candidate information
242 simulation result information
243 sample point information
244 program
250 arithmetic processing unit
251 simulation execution unit
252 main component analysis execution unit
253 sample point selection unit
254 weight calculation unit
255 data conversion unit
256 inverse conversion unit
257 output unit
300 drive device
310 communication I/F unit
320 storage unit
321 control input candidate information
322 sample point information
323 program
330 arithmetic processing unit
331 sample point extraction unit
332 evaluation value estimation unit
333 selection unit
334 driving unit
400 computing device
401 CPU
402 ROM
403 RAM
404 program group
405 storage device
406 drive
407 communication interface
408 input/output interface
409 bus
410 storage medium
411 communication network
421 execution unit
422 analysis unit
423 determination unit
500 drive device
521 estimation unit
522 selection unit
523 driving unit

What is claimed is:

1. A computing device comprising:
at least one memory configured to store instructions; and
at least one processor configured to execute instructions to:
simulate a state of a drive device after the drive device is driven according to a control input, on a basis of a value of the control input capable of being input to the drive device;
select a main component axis by performing main component analysis on state distribution of the drive device that is specified through simulations performed a plurality of times; and
determine a value to be used for evaluating a candidate for the control input to be input to the drive device, on a basis of a selection result.

2. The computing device according to claim 1, wherein the at least one processor is configured to execute the instructions to
select a plurality of sample points indicating the state of the drive device from states on the main component axis, as a value to be used for evaluating the candidate for the control input.

3. The computing device according to claim 2, wherein the at least one processor is configured to execute the instructions to
select the sample points, and for each of the selected sample points, calculate a weight corresponding to distribution of the states on the main component axis.

4. The computing device according to claim 3, wherein the at least one processor is configured to execute the instructions to
calculate each of the sample points and the weight as values to be used for estimating an evaluation value corresponding to the candidate for the control input to be input to the drive device.

5. The computing device according to claim 1, wherein the at least one processor is configured to execute the instructions to
determine a value to be used for approximately evaluating Expression 1, as the value to be used for evaluating the candidate for the control input to be input to the drive device.
$$\int f ( x ) p ( x ) dx . \qquad [ Expression 1 ]$$

6. The computing device according to claim 1, wherein the at least one processor is configured to execute the instructions to:
perform predetermined conversion processing on the state distribution of the drive device that is specified through simulations performed a plurality of times; and
select the main component axis on a basis of a conversion result.

7. The computing device according to claim 1, wherein the at least one processor is configured to execute the instructions to
output the determined value to the drive device.

8. A determination method comprising, by an information processing device:
simulating a state of a drive device after the drive device is driven according to a control input, on a basis of a value of the control input capable of being input to the drive device;
selecting a main component axis by performing main component analysis on state distribution of the drive device that is specified through simulations performed a plurality of times; and
determining a value to be used for evaluating a candidate for the control input to be input to the drive device, on a basis of a selection result.

9. (canceled)

10. A drive device comprising:
at least one memory configured to store instructions; and
at least one processor configured to execute instructions to:
estimate an evaluation value corresponding to a candidate for a control input, on a basis of a value used for evaluating the candidate for the control input to be input to the drive device and on a basis of a state of the drive device, the value used for evaluating being determined on a basis of a result of main component analysis with respect to a simulation result using a value of the control input capable of being input to the drive device;
select a control input to be actually input from among a plurality of the candidates for the control input on a basis of an estimation result; and
drive the drive device on a basis of a selection result.

11. The drive device according to claim 10, further comprising:
a storage unit that stores information in which information representing a candidate for the control input and a value to be used for evaluating the candidate for the control input are associated with each other, wherein the at least one processor is configured to execute the instructions to:
extract a value corresponding to the candidate for the control input subjected to evaluation, from information stored in the storage unit; and
estimate the evaluation value on a basis of the extracted value and the state of the drive device.

12. The drive device according to claim 11, wherein
a value determined previously by a computing device is acquired from the computing device and stored in the storage unit in advance, the computing device determining the value to be used for evaluating the candidate for the control input on a basis of the value of the control input capable of being input to the drive device.

13. The drive device according to claim 10, wherein
the value to be used for evaluating the candidate for the control input includes information representing a sample point indicating a state of the drive device and information representing a weight corresponding to the sample point.

14. The drive device according to claim 13, wherein the at least one processor is configured to execute the instructions to
estimate the evaluation value by solving Expression 1 provided below, by using the sample point and the weight.
$$\int f ( x ) p ( x ) dx \approx \frac{{\sum }_{j = 1}^{n} f ( {x}_{i} + {x}_{j}^{m} ) {{\tilde{p}}_{j}^{m}}^{}}{{\sum }_{j = 1}^{n} {\tilde{p}}_{j}^{m}} . \qquad [ Expression 1 ]$$

15. (canceled)

16. (canceled)
